(19) United States
(12) Patent Application Publication
(10) Pub. No.: US 2026/0131331 A1
(43) Pub. Date: May 14, 2026

(54) THERMAL CYCLER

(71) Applicant: Seegene, Inc., Seoul (KR)

(72) Inventors: Nam Su YUK, Seoul (KR); Young Jae MOK, Seoul (KR); Sang Min KIM, Seoul (KR); Ho Jun JEONG, Seoul (KR); Kyung Tae AN, Seoul (KR); Gi Hun LEE, Seoul (KR)

(21) Appl. No.: 19/442,762

(22) Filed: Jan. 7, 2026

Related U.S. Application Data
(63) Continuation of application No. PCT/KR2024/009613, filed on Jul. 5, 2024.

(30) Foreign Application Priority Data
Jul. 7, 2023 (KR) 10-2023-0088557
Jul. 7, 2023 (KR) 10-2023-0088566

(51) Int. Cl. B01L 3/00; B01L 7/00

(52) U.S. Cl. CPC B01L 3/50851; B01L 7/52; B01L 2300/1822; B01L 2300/1883; B01L 2300/1894

(57) ABSTRACT

A thermal cycler may include a thermal unit comprising a thermal block for receiving a sample and a thermal element in thermal contact with the thermal block. The thermal cycler may also include a control unit comprising a control circuit board configured to control thermal cycling of the thermal element. The thermal cycler may further include a cooling unit comprising a duct positioned between the thermal unit and the control unit and configured to provide an air flow passage. The thermal cycler may further include a cooling fan configured to provide an air flow to the duct, wherein the thermal unit, the control unit, and the cooling unit are combined into an integrated module.

### CROSS REFERENCE TO RELATED APPLICATIONS

This is a continuation application of International Patent Application No. PCT/KR2024/009613, filed on Jul. 5, 2024, which claims priority to Korean Patent Application No. 10-2023-0088557 filed on Jul. 7, 2023, and Korean Patent Application No. 10-2023-0088566 filed on Jul. 7, 2023, contents of each of which are incorporated herein by reference in their entireties.

### BACKGROUND

### Technical Field

The disclosure relates to a thermal cycler used for detecting a target analyte and an apparatus for detecting a target analyte having the same.

### Description of Related Technology

Nowadays people's interest in health increases and life expectancy extends. Thus, accurate analysis of pathogens and in vitro nucleic acid-based molecular diagnosis such as genetic analysis for a patient become significant, and the demand therefor is on the rise. Nucleic acid-based molecular diagnosis is performed by extracting nucleic acids from a sample and confirming whether a target nucleic acid is present in the extracted nucleic acids.

### SUMMARY

One aspect is a thermal cycler comprising a thermal module provided as an integrated module.

Another aspect is a thermal cycler comprising a thermal module which adopts a cooling structure capable of cooling a thermal unit and a control unit thereof at the same time.

Another aspect is a thermal cycler comprising: a thermal unit comprising a thermal block for receiving a sample and a thermal element in thermal contact with the thermal block; a control unit comprising a control circuit board configured to control thermal cycling of the thermal element; and a cooling unit comprising a duct positioned between the thermal unit and the control unit and configured to provide an air flow passage, and a cooling fan configured to provide an air flow to the duct, wherein the thermal unit, the control unit, and the cooling unit are combined into an integrated module.

The thermal unit, the cooling unit, and the control unit may be combined in this order, and the thermal unit and the control unit are simultaneously cooled by air passing through a duct of the cooling unit.

The thermal unit, the cooling unit, and the control unit may be stacked downward in this order.

A thermal cycler may further comprise a connection unit electrically connecting the thermal unit and the control unit, wherein the connection unit extends in a vertical direction at one side of the integrated module and is detachably coupled to the integrated module.

The thermal unit may further comprise a thermal circuit board electrically connected to the thermal element, and wherein the thermal circuit board comprises a first connection portion connected to the control circuit board.

A thermal cycler may further comprise a connection unit electrically connecting the first connection portion and a second connection portion of the control circuit board, and detachably coupled to the first connection portion and the second connection portion.

The cooling fan may comprise a pair of cooling fans respectively located at both ends of the duct, wherein the cooling fans are installed at side surfaces of the integrated module in a first direction, and wherein the first connection portion, the second connection portion, and the connection unit are all located at one of side surfaces of the integrated module in a second direction crossing the first direction.

The duct of the cooling unit may extend in a first direction, the thermal unit comprises a first heat sink configured to dissipate heat of the thermal block, and the control unit comprises a second heat sink configured to dissipate heat of the control circuit board.

The first heat sink and the second heat sink may be spaced apart from each other.

Each of the first heat sink and the second heat sink may comprise a plurality of cooling fins extending in the first direction, and the cooling fins are arranged in a second direction perpendicular to the first direction.

The cooling fins of the first heat sink and the cooling fins of the second heat sink may be alternately disposed in the second direction.

A flow of air passing through the duct may be configured to cool both the thermal unit and the control unit.

The thermal unit may comprise a first heat sink configured to dissipate heat from the thermal block, wherein the control unit comprises a second heat sink configured to dissipate heat from the control circuit board, and wherein a flow of air passing through the duct is configured to cool the first heat sink and the second heat sink at the same time.

Thermal element, the first heat sink, the second heat sink, and the control circuit board may be arranged in this order.

The thermal element may comprise a thermoelectric element and an electrical resistance element, and wherein the electrical resistance element is located on a top surface of the thermal block.

The thermal block may comprise a plurality of recesses capable of accommodating each of a plurality of wells of a reaction container, and wherein the electrical resistance element is provided as a flexible heater comprising holes corresponding to the recesses of the thermal block.

The thermal unit may comprise a first heat sink configured to dissipate heat of the thermal block, wherein the thermoelectric element is disposed between the thermal block and the first heat sink, wherein a plurality of thermoelectric elements that are independently controlled are disposed side by side in one direction of the thermal block, and wherein the duct extends in the same direction as a direction in which the thermoelectric elements are disposed.

The cooling unit may further comprise a middle frame to which the cooling fan is coupled, and wherein the thermal unit and the control unit are coupled to the middle frame in opposite directions, respectively.

A thermal cycler may further comprise a first cover coupled to one side of the middle frame and configured to cover the top of the thermal unit and a second cover coupled to the other side of the middle frame and configured to cover the bottom of the control unit.

The first cover may comprise a plurality of openings corresponding to the recesses of the thermal block.

Another aspect is a thermal cycler comprising: a thermal block on which a reaction container for receiving a sample is seated; a thermal element in thermal contact with the thermal block; a first heat sink comprising a first cooling fin for dissipating heat of the thermal block; a control circuit board for controlling thermal cycling of the thermal element; a second heat sink comprising a second cooling fin for dissipating heat of the control circuit board; a duct providing a flow passage for air passing through the first heat sink and the second heat sink; and a cooling fan for providing an air flow to the duct, wherein the flow of air passing through the duct is configured to simultaneously cool the first heat sink and the second heat sink.

The thermal element, the first heat sink, the second heat sink, and the control circuit board may be arranged in a downward direction in order.

The thermal block may comprise a plurality of recesses accommodating each well of the reaction container, wherein the thermal element comprises a thermoelectric element and an electrical resistance element, and wherein the electrical resistance element is provided as a flexible heater comprising holes corresponding to the recesses of the thermal block.

Another aspect is a thermal cycler comprising: a thermal unit comprising a thermal block for receiving a sample and a thermal element in thermal contact with the thermal block; a control unit comprising a control circuit board configured to control thermal cycling of the thermal element; a cooling unit comprising a duct positioned between the thermal unit and the control unit and configured to provide an air flow passage, and a cooling fan configured to provide an air flow to the duct; and a connection unit configured to electrically connect the thermal unit and the control unit, wherein the thermal unit, the control unit, the cooling unit, and the connection unit are combined into an integrated module.

The thermal unit, the cooling unit, and the control unit may be combined in a first direction in this order, and the connection unit is located at one side of the thermal unit and the control unit and extends in a direction parallel to the first direction.

Another aspect is a thermal cycler comprising: a thermal block in which a reaction container comprising a plurality of wells for receiving a sample is seated and which comprises a plurality of recesses configured to receive the respective wells; a flexible heater for thermal block configured to heat the thermal block on the thermal block; a heat insulating member configured to cover the top of the flexible heater for thermal block; a first cover configured to cover the top of the heat insulating member and the side of the thermal block; a thermoelectric element configured to exchange heat with the thermal block under the thermal block; and a heat sink thermally connected to the thermoelectric element, wherein the flexible heater for thermal block, the heat insulating member, and the first cover comprise openings corresponding to the respective recesses of the thermal block.

The thermal block may comprise a plurality of pillars protruding from a top surface, wherein each of the recesses is formed in the pillar, and wherein the pillar penetrates through the flexible heater for thermal block and holes in the heat insulating member.

According to an embodiment of the disclosure, it is possible to provide a thermal control board for controlling a thermal unit separately from a main control board and is further possible to provide the thermal unit and the thermal control board as an integrated module.

Also, according to an embodiment, it is possible to provide the thermal module as an integrated module, thereby facilitating replacement or repair.

Also, according to an embodiment, it is possible to reduce the inconvenience of retuning a thermal control unit provided as a part of the main control board for device optimization and reduce the replacement time when the thermal cycler replaces or repairs a thermal block.

Also, according to an embodiment, it is possible to reduce the inconvenience of separately tuning or upgrading the main control board, thereby reducing the replacement time when the specification of the thermal block is changed.

Also, according to an embodiment, it is possible to reduce electromagnetic wave influence by locating the controller of the thermal block inside the integrated housing, thereby enabling more precise cycling control.

Also, according to an embodiment, it is possible to maximize a heat-sealing effect as the thermal block is located inside the integrated housing, thereby enabling precise and predictable temperature control.

According to another embodiment of disclosure, it is possible to simultaneously cool the thermal unit and the control unit by disposing the thermal unit on one side of the cooling unit and disposing the control unit on the other side facing the cooling unit.

Also, according to an embodiment, it is possible to improve the cooling efficiency of the thermal control board, so that control stability may be improved.

It should be appreciated that the effects of the disclosure are not limited thereto but may rather comprise all effects inferable from the configuration of the disclosure described in the detailed description or the claims of the disclosure.

### BRIEF DESCRIPTION OF THE DRAWINGS

The above and other objects, features, and advantages of the disclosure will be more clearly understood from the following detailed description, taken in conjunction with the accompanying drawings.

FIG. 1 is a perspective view illustrating a thermal module of a thermal cycler according to an embodiment of the disclosure.

FIG. 2 is an exploded perspective view of FIG. 1.

FIG. 3 is a view illustrating FIG. 2 when viewed from below.

FIG. 4 is a detailed exploded perspective view of FIG. 2.

FIG. 5 is a view illustrating FIG. 4 when viewed from below.

FIG. 6 is a side view of a thermal module.

FIG. 7 is a cross-sectional view taken along line A-A of FIG. 6.

FIG. 8 is an exploded perspective view of a thermal unit.

FIG. 9 is a diagram illustrating a state of FIG. 8 viewed from below.

FIG. 10 is a view illustrating a configuration of a controller of a thermal cycler.

### DETAILED DESCRIPTION

Polymerase chain reaction (PCR) is the most widely used nucleic acid amplification method, and the PCR process is performed by repeated cycling comprising denaturation of double-stranded DNA, annealing of oligonucleotide primers to the DNA templates and extension of primers by DNA polymerase.

A general real-time polymerase chain reaction (PCR) device comprises a thermal cycler provided at a lower portion to generate a nucleic acid amplification reaction, and an optics mechanism provided at an upper portion to analyze or monitor the nucleic acid amplification reaction in real time.

The denaturation of the DNA proceeds at about 95° C., and the annealing and primer extension proceeds at a temperature of 55° C. to 75° C., which is lower than 95° C. Therefore, the thermal cycler repeats the process of raising and lowering the temperature of the reaction containers comprised in the heat block to perform a nucleic acid amplification reaction of the sample comprised in the reaction containers. In this case, the heat provided to the heat block is generated by the heat generating element, and the heat generated by the heat generating element is discharged to the outside through the heat radiating plate.

At least one thermal cycler for generating a nucleic acid amplification reaction is provided, and an optics mechanism measures fluorescence generated from a reaction container in which the amplification reaction is generated by each thermal cycler.

Hereinafter, the disclosure will be explained with reference to embodiments and example drawings. The embodiments are for illustrative purposes only, and it should be apparent to a person having ordinary knowledge in the art that the scope of the disclosure is not limited to the embodiments.

In addition, in adding reference numerals to the components of each drawing, it should be noted that same reference numerals are assigned to same components as much as possible even though they are shown in different drawings. In addition, in describing the embodiments of the disclosure, when it is determined that a detailed description of a related well-known configuration or function interferences with the understanding of the embodiments of the disclosure, the detailed description thereof will be omitted.

In addition, in describing the components of the embodiments of the disclosure, terms such as first, second, A, B, (a), (b), (a), and (ii) may be used. These terms are only for distinguishing the components from other components, and the nature or order of the components is not limited by the terms. When a component is described as being “connected”, “coupled”, or “fastened” to other component, the component may be directly connected or fastened to the other component, but it will be understood that another component may be “connected”, “coupled”, or “fastened” between the components.

An embodiment of the disclosure may relate to a detection device for detecting a target analyte in a sample.

In the disclosure, the term “sample” may comprise a biological sample (e.g., cells, tissues, and fluids from a biological source) and a non-biological sample (e.g., food, water, and soil). Examples of the biological sample may comprise viruses, bacteria, tissues, cells, blood (e.g., whole blood, plasma, and serum), lymph, bone marrow fluid, salvia, sputum, swab, aspiration, milk, urine, feces, ocular fluid, semen, brain extract, spinal fluid, joint fluid, thymus fluid, bronchoalveolar lavage fluid, ascites, and amniotic fluid. Also, the sample may comprise natural nucleic acid molecules isolated from a biological source and synthetic nucleic acid molecules. According to an embodiment of the disclosure, the sample may comprise an additional substance such as water, deionized water, saline solution, pH buffer, acid solution or alkaline solution.

In the disclosure, the sample may comprise substances necessary for detecting a target analyte. For example, the sample may comprise an optical label. The optical label refers to a label that generates an optical signal depending on the presence of a target nucleic acid. The optical label may be a fluorescent label. The fluorescent label useful herein may comprise any molecule known in the art.

A target analyte refers to a substance that is the subject of analysis. The analysis may mean obtaining information on, for example, the presence, amount, concentration, sequence, activity, or property of the analyte in the sample. The analyte may comprise various substances (e.g., biological substance and non-biological substance such as compounds). Specifically, the analyte may comprise a biological substance such as nucleic acid molecules (e.g., DNA and RNA), proteins, peptides, carbohydrates, lipids, amino acids, biological compounds, hormones, antibodies, antigens, metabolites, or cells. According to an embodiment of the disclosure, the analyte may be nucleic acid molecules.

An apparatus for detecting a target analyte according to an embodiment of the disclosure may be an apparatus for detecting a target nucleic acid. The apparatus for detecting a target analyte allows a nucleic acid reaction in a sample to proceed, and through this, a target nucleic acid is detected.

The nucleic acid reaction refers to sequential physical and chemical reactions which generate a signal depending on the presence of a nucleic acid of a specific sequence in the sample or the amount thereof. The nucleic acid reaction may comprise the binding of a nucleic acid of a specific sequence in a sample to other nucleic acids or substances, or replication, cleavage, or decomposition of a nucleic acid of a specific sequence in the sample. The nucleic acid reaction may involve a nucleic acid amplification reaction. The nucleic acid amplification reaction may comprise amplification of a target nucleic acid. The nucleic acid amplification reaction may specifically amplify the target nucleic acid.

The nucleic acid reaction may a signal-generation reaction which generates a signal depending on the presence/absence of a target nucleic acid in the sample or the amount thereof. The signal-generation reaction may be a technique of genetic analysis such as PCR, real-time PCR, or microarray.

The thermal cycler according to an embodiment of the disclosure may be an apparatus for detecting a nucleic acid and may detect a signal generated depending on the presence of a target nucleic acid. The apparatus for detecting a nucleic acid may amplify and detect a signal along with nucleic acid amplification. Alternatively, the apparatus for detecting a nucleic acid may amplify and detect a signal without accompanying nucleic acid amplification. Preferably, a signal is detected by accompaniment of nucleic acid amplification.

The thermal cycler according to an embodiment of the disclosure may comprise a nucleic acid amplifier.

A nucleic acid amplifier refers to an apparatus for performing a nucleic acid amplification reaction which amplifies a nucleic acid having a specific nucleotide sequence. Examples of the method for amplifying a nucleic acid include polymerase chain reaction (PCR), ligase chain reaction (LCR), strand displacement amplification (SDA), transcription-mediated amplification, nucleic acid sequence-based amplification (NASBA), and Q-beta Replicase.

The thermal cycler according to an embodiment of the disclosure may be an apparatus that performs a nucleic acid amplification reaction while undergoing temperature changes. For example, the nucleic acid amplifier may carry out a denaturing step, an annealing step, and an extension (or amplification) step to amplify a deoxyribonucleic acid (DNA) having a specific base sequence.

In the denaturing step, a sample and reagent solution containing double-stranded DNA templates is heated to a specific temperature, for example about 95° C., to separate double-stranded DNA into single-stranded DNA. In the annealing step, an oligonucleotide primer having a nucleotide sequence complementary to the nucleotide sequence of a nucleic acid to be amplified is provided, and the primer and the separated single-stranded DNA are cooled down to a specific temperature, for example 60° C., to promote the primer binding to the specific nucleotide sequence of the single-stranded DNA to form a partial DNA-primer complex. In the extension step, the solution is maintained at a specific temperature, for example 72° C., after the annealing step to form double-stranded DNA by DNA polymerase based on the primer of the partial DNA-primer complex.

By repeating the aforementioned three steps (e.g.,) 10 to 50 times, the DAN with the specific nucleotide sequence may be exponentially amplified. In some cases, the nucleic acid amplifier may perform the annealing step and extension step simultaneously. In this case, the nucleic acid amplifier may complete one cycle by performing two steps including a denaturing step and an annealing/extension step.

Particularly, a thermal cycler according to an embodiment of the disclosure may be an apparatus for performing a nucleic acid amplification reaction with temperature changes and a reaction of generating an optical signal depending on the presence of a nucleic acid and detecting the generated optical signal.

A thermal cycler according to an embodiment of the disclosure may comprise a thermal module, an optical module, and a main controller. The optical module may comprise a light emitting unit and a detection unit.

The light emitting unit according to an embodiment of the disclosure supplies an appropriate optical stimulation to the sample accommodated in the sample holder, and the detection unit detects an optical signal generated from the sample in response to the optical stimulation.

The optical signal may be luminescence, phosphorescence, chemiluminescence, fluorescence, polarized fluorescence, or another colored signal. The optical signal may be an optical signal that gives optical stimulation to a sample and is generated in response thereto.

The thermal module according to an embodiment of the disclosure may perform thermal cycling while applying heat to the sample holder and cooling the sample holder. For example, the thermal module may perform a nucleic acid amplification reaction of the sample while performing thermal cycling.

The sample holder has a sample accommodating portion for accommodating a sample. The sample holder is a component that directly accommodates a sample in the sample accommodating portion or accommodates a reaction container containing a sample.

In the disclosure, the expression “the sample holder may accommodate a sample” may be used to comprehensively indicate a case in which the sample holder directly accommodates a sample in the sample accommodating unit or accommodates a reaction container comprising a sample.

The sample holder positions the sample at a predetermined position so that an optical stimulus from the light emitting unit reaches the sample and an optical signal generated from the sample reaches the detection unit.

The sample holder may be supplied with heat from the thermal element, and heat is transferred to the sample accommodated directly in the sample holder or accommodated in the reaction container.

The reaction container may be made of various materials, for example, plastic, ceramic, glass, or metal.

The sample holder accommodating the reaction container may have a block or plate shape. The sample holder may comprise a recess, for example, a well, accommodating the reaction container, or may have a flat surface. Alternatively, the recess formed in the sample holder may comprise a hole passing through the sample holder.

One sample holder is provided to accommodate one or more samples. A representative example of the sample holder is a thermal block or a heat block. The sample holder may comprise one or more recesses (wells or holes) accommodating the reaction container.

The phrase “the sample holder accommodates the reaction containers” may mean either that each of the plurality of recesses formed in the sample holder holds a reaction container, or that one or more reaction containers are placed in designated positions on the sample holder.

In addition, the sample holder may have a structure capable of guiding the position of the reaction container or fixing the sample reaction container. For example, the sample holder may comprise an inclined surface at an inlet of the recess to guide the reaction container to be inserted into the recess.

The reaction container is used to accommodate the sample to be analyzed. The reaction container comprises various types of containers, for example, tubes, vials, strips to which a plurality of single tubes connected, plates to which a plurality of tubes connected, micro-cards, chips, cuvettes, vessels, or cartridges.

The sample holder that directly accommodates the sample may have the shape of the reaction container described above and may be formed of the material of the reaction container described above.

According to an embodiment, the sample holder may be formed of a material having thermal conductivity. When the sample holder is in direct contact with the sample or in contact with the reaction containers, heat may be transferred from the sample holder to the sample or the sample in the reaction container. The sample holder may be made of iron, aluminum, gold, silver, nickel, copper, or an alloy containing at least one of them, or may be made of plastic or ceramic in some cases.

As described above, the sample holder is formed to receive a plurality of samples, and a reaction for detection such as a nucleic acid amplification reaction may occur by adjusting the temperature of the plurality of samples. For example, when the sample holder is a thermal block in which a plurality of wells are formed, the sample holder may be formed as one thermal block, and all wells of the thermal block may be formed so as not to be thermally independent from each other. In this case, the temperatures of all wells in which the samples are accommodated in the sample holder are the same, and the temperatures of the accommodated samples cannot be adjusted according to different protocols.

As another example, the sample holder may be configured to adjust the temperature of some of the samples accommodated according to different protocols. In other words, the sample holder may comprise two or more thermally independent reaction zones. Each of the reaction zones is thermally independent. Heat does not transfer from one reaction zone to another. For example, an insulating material or an air gap may be present between the reaction zones. The temperature of each of the reaction zones may be independently controlled. A reaction protocol comprising temperature and time may be individually set for each of the reaction zones, and each of the reaction zones may perform a reaction by an independent protocol. Since the reaction proceeds by an independent protocol in the reaction zones, the light detection time points in the reaction zones are independent of each other.

According to an embodiment, the sample holder may be divided into a plurality of sample areas. The sample area is an area divided by an excitation light irradiation area of the light emitting unit.

That is, the light emitting unit according to an exemplary embodiment of the disclosure may comprise a plurality of light source elements, and the sample holder may be divided into a plurality of sample areas. Each of the plurality of sample areas refers to an area on a sample holder in which samples in which an optical signal detection reaction is performed by the same light source element are located. In other words, the sample area of the disclosure refers to a group of reactive sites in which an optical signal detection reaction is performed by the same light source element among a plurality of reactive sites comprised in the sample holder. That is, the sample area is an area divided by the excitation light irradiation area of the light source device. One or more wells or holes may be formed in each sample area.

According to an embodiment, when the sample holder is a thermal block, an empty space may be formed between the wells to reduce heat capacity. For example, a groove or a hole may be formed between wells of the thermal block to reduce heat capacity. In addition, it is possible to reduce an edge effect by differently designing the heat capacity of the middle area and the edge area of the thermal block. The edge effect means a phenomenon in which the temperature rises later when heating in the edge area than in the middle area of the thermal block, and the temperature falls quickly when cooling.

According to an embodiment, the plurality of wells or the plurality of holes in the sample holder are formed in a regular arrangement. For example, the plurality of wells are formed in a matrix form in which columns and rows are formed. Various forms may be formed, such as a 16-well in the form of 4 by 4, a 24-well in the form of 6 by 4, a 32-well in the form of 4 by 8, a 60-well in the form of 5 by 12, a 90-well in the form of 5 by 18, a 96-well in the form of 8 by 12, or a 384-well in the form of 16 by 24, and although not limited thereto, a 16-well, a 32-well, a 96-well, or a 384-well may be mainly used. The shape, size, and the like of the wells may be determined to be suitable for the reaction container being accommodated.

Hereinafter, embodiments of the disclosure will be described in detail with reference to the accompanying drawings so that those skilled in the art to which the disclosure pertains may easily implement the disclosure.

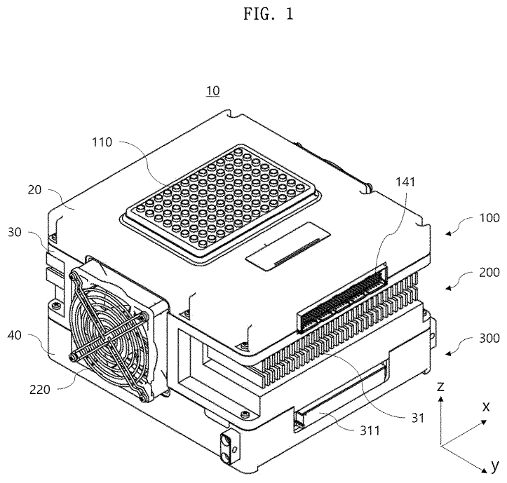

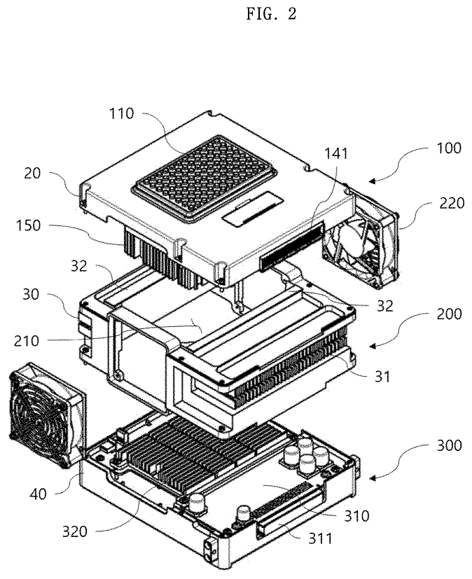

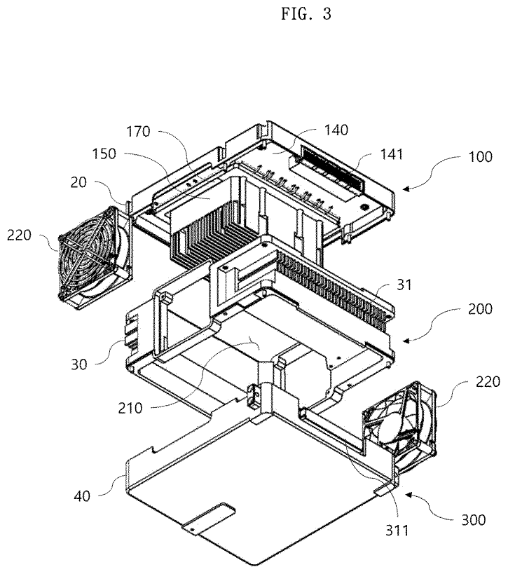

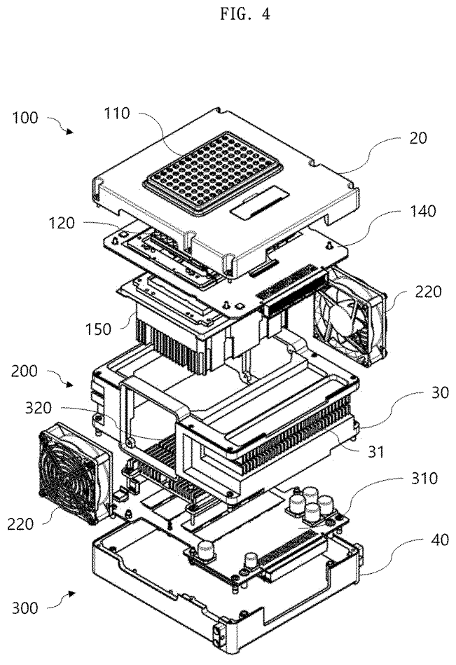

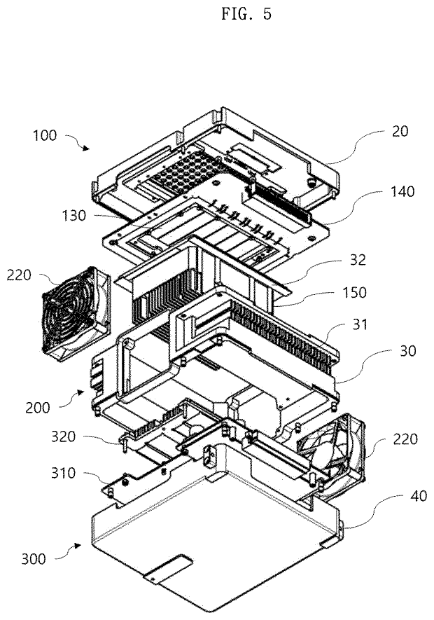

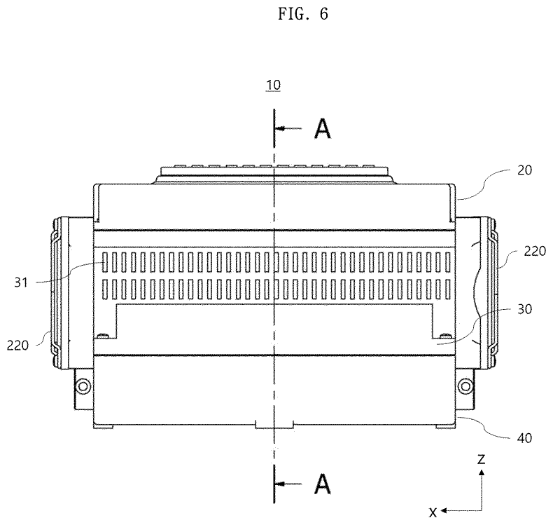

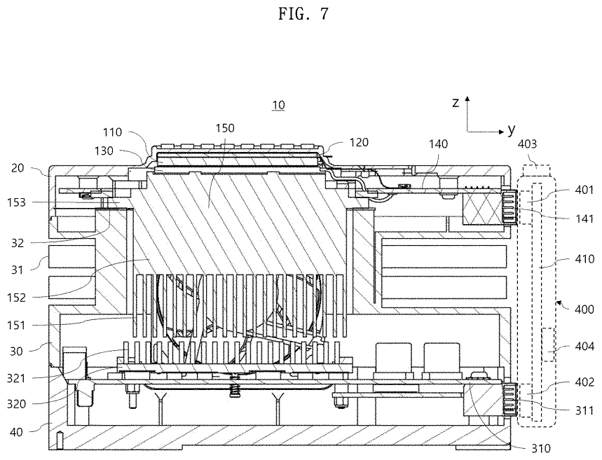

FIG. 1 is a perspective view illustrating a thermal module of a thermal cycler according to an embodiment. FIG. 2 is an exploded perspective view of FIG. 1, and FIG. 3 is a view illustrating FIG. 2 when viewed from below. FIG. 4 is a detailed exploded perspective view of FIG. 2, and FIG. 5 is a view illustrating FIG. 4 when viewed from below. FIG. 6 is a side view of a thermal module, and FIG. 7 is a cross-sectional view taken along line A-A of FIG. 6.

Hereinafter, in FIG. 1, the x-axis direction may be used in the same direction as the first direction or the longitudinal direction of the thermal block, the y-axis direction may be used in the same direction as the second direction or the width direction of the thermal block, and the z-axis direction may be used in the same direction as the vertical direction.

Referring to FIGS. 1 to 7, the thermal cycler according to an embodiment of the disclosure may comprise a thermal module 10 for performing thermal cycling while heating and cooling the sample holder.

The thermal module 10 may comprise a thermal unit 100, a control unit 300, and a cooling unit 200.

The thermal unit 100 may comprise a thermal block 110 on which a reaction container for receiving a sample is seated, a thermal element in thermal contact with the thermal block 110, and a first heat sink 150 for dissipating heat of the thermal block 110.

The control unit 300 may comprise a control circuit board 310 for controlling the thermal element, and a second heat sink 320 for dissipating heat from the control circuit board 310.

In addition, the cooling unit 200 may comprise a cooling fan 220 to provide an air flow to the first heat sink 150 and the second heat sink 320, and a duct 210 to provide an air flow passage.

The thermal module 10 according to an embodiment of the disclosure may be provided as an integrated module in which the thermal unit 100, the control unit 300, and the cooling unit 200 are combined. The thermal unit 100, the control unit 300, and the cooling unit 200 may be combined in this order to provide an integrated module. For example, in the thermal module 10, the thermal unit 100, the cooling unit 200, and the control unit 300 may be stacked in this order in a downward direction.

The cooling unit 200 may simultaneously cool the thermal unit 100 and the control unit 300. Specifically, the first cooling fin 151 of the first heat sink 150 of the thermal unit 100 may be positioned at one side of the duct 210 of the cooling unit 200, and the second cooling fin 321 of the second heat sink 320 of the control unit 300 may be positioned at the other side of the duct 210. As an example, the first cooling fin 151 of the first heat sink 150 of the thermal unit 100 may be positioned above the duct 210, and the second cooling fin 321 of the second heat sink 320 of the control unit 300 may be positioned below the duct 210.

In addition, the thermal module 10 may comprise a first cover 20, a middle frame 30, and a second cover 40.

The first cover 20 may be coupled to one side of the middle frame 30, and the second cover 40 may be coupled to the other side of the middle frame 30. The first cover 20 and the second cover 40 may face each other. For example, the first cover 20 may be coupled to an upper portion of the middle frame 30, and the second cover 40 may be coupled to a lower portion of the middle frame 30. The first cover 20, the middle frame 30, and the second cover 40 may be stacked in a downward direction.

Hereinafter, the cover and frame terms do not limit the shape and structure of the object. In some cases, the cover or frame may be referred to as a case or housing.

The first cover 20 (or a top cover) is opened at a place where the reaction container is seated and exposes a portion of a top surface of the thermal block 110 through openings of the first cover 20. The first cover 20 comprises the openings to open a plurality of recesses of the thermal block 110. For example, the opening of the first cover 20 may be provided as a through-hole into which the well of the reaction container may be inserted. In addition, the opening of the first cover 20 may be a position corresponding to the recess of the thermal block 110. When the reaction container is placed on the thermal block 110, the well of the reaction container may be accommodated in the recess of the thermal block 110 by passing through the opening of the first cover 20.

The first cover 20 may be provided to surround a side surface of the thermal block 110. The middle frame 30 may be coupled to a lower portion of the first cover 20.

The first cover 20 may be provided to cover both the top and the side of the thermal block 110 and may form openings corresponding to the recess of the thermal block 110. The opening of the first cover 20 is essential for the well of the reaction container to be accommodated in the recess of the thermal block 110. As described above, the first cover 20 may be provided to cover not only the side of the thermal block 110 but also the top thereof, thereby maximizing the heat-sealing effect in which the heat of the thermal block 110 is discharged to the outside, and accordingly, it is possible to control the temperature precisely and predictably. In addition, the first cover 20 may minimize introduction of foreign substances such as external dust into the thermal block 110. In addition, the first cover 20 may protect a flexible heater for thermal block 121 to be described later.

The middle frame 30 may form a duct 210 forming an air flow path. A pair of cooling fans 220 may be installed at both sides of the duct 210. For example, the suction cooling fan 220 may be installed at one side of the middle frame 30, and the discharge cooling fan 220 may be installed at the other side facing the middle frame 30. A second cover 40 may be coupled to a lower portion of the middle frame 30.

The second cover 40 (or a bottom cover) may be provided to surround a bottom surface and a side surface of the control circuit board 310. In addition, an anti-shock structure may be adopted between the second cover 40 and the control circuit board 310.

As described above, the thermal module 10 may provide an independent integrated module in which the first cover 20, the middle frame 30, and the second cover 40 are combined to form one housing. The thermal module 10 provided as the integrated module may be easily repaired and replaced. When the thermal module 10 needs to be repaired or replaced, the corresponding operation may be performed after the integrated module is separated from the thermal cycler. When the thermal module 10 is not provided as an integrated module, the thermal unit, the control unit, the cooling fan, and the like should be separately separated and assembled, thereby increasing the difficulty of work and time.

In addition, by using the thermal module 10 provided as the integrated module, it is possible to stably change the specification of the thermal module 10. For example, a manufacturer may prepare thermal modules 10 having various specifications, and when a customer wants to change a specification, the manufacturer may simply change the specification by replacing only the thermal module 10 in the thermal cycler. For example, the specification of the thermal block 110 may comprise 6 wells, 12 wells, 24 wells, 48 wells, 96 wells, 192 wells, or 384 wells. In addition, when the thermal block 110 is provided so that the plurality of reaction containers may be disposed, the specification of the thermal block 110 may comprise 96×1, 96×2, 96×3, or the like.

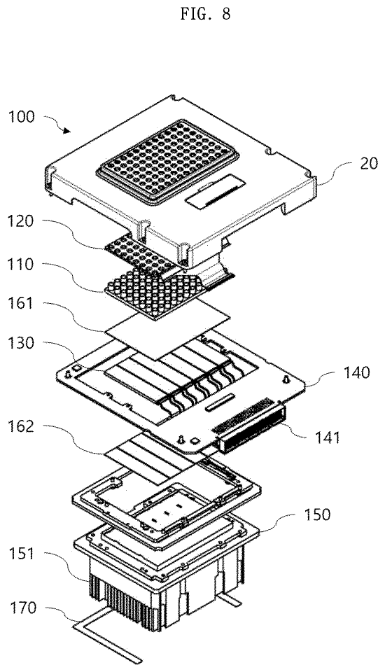

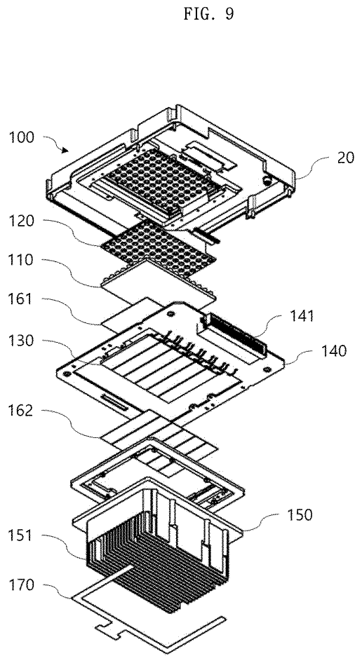

FIG. 8 is an exploded perspective view of the thermal unit 100, and FIG. 9 is a view illustrating a state of FIG. 8 when viewed from below. The thermal unit 100 will be described with reference to FIGS. 8 and 9.

The thermal unit 100 may comprise a thermal block 110, a thermal element, a thermal circuit board 140, and a first heat sink 150.

The thermal block 110 may be provided to accommodate or support the reaction container and thermally contact the reaction container to apply heat to the reaction container or absorb heat from the reaction container. For example, the thermal block 110 may be formed of aluminum (Al) or an aluminum alloy material having excellent thermal conductivity.

According to an embodiment, the reaction container may be provided as a well-plate in which a plurality of wells are arranged in rows and columns, and the thermal block 110 may have a plurality of recesses capable of accommodating each of the wells of the well-plate. In addition, since the inside of the recesses of the thermal block 110 is coated (for example, Teflon), it is possible to prevent the well of the well plate from adhering to the thermal block 110 at a high temperature.

The thermal element may comprise a thermoelectric element 130 and an electrical resistance element 120.

The thermoelectric element 130 may be positioned below the thermal block 110. Specifically, the thermoelectric element 130 may be provided between the thermal block 110 and the first heat sink 150.

In addition, the electrical resistance element 120 may be positioned above the thermal block 110. Specifically, the electrical resistance element 120 may be provided between the first cover 20 and the thermal block 110.

The thermoelectric element 130 comprises a Peltier element or a Thermoelectric Cooler (TEC). The thermoelectric element 130 may generate heat flux at a junction of dissimilar materials using the Peltier effect. The thermoelectric element 130 may function as a heat pump that transfers heat to the thermal block 110 or takes away heat from the thermal block 110. The thermoelectric element 130 may be used for both heating and cooling the thermal block 110. In addition, the thermoelectric element 130 may be used for thermal cycling in which heating and cooling are repeated, thereby shortening a process time.

The thermal block 110 may be divided into a plurality of thermal zones. The thermal zone is an area defined according to the arrangement of the thermal element or the temperature sensor. The thermal zone may be a physically divided area but may be a virtual area divided for convenience for temperature control.

The thermal element may comprise a plurality of thermoelectric elements 130 disposed adjacent to each other. For example, the thermal block 110 may be divided into at least six thermal zones while six bar-type thermoelectric elements 130 are arranged side by side. In addition, by independently controlling each of the thermoelectric elements 130, the temperature of the corresponding thermal zone may be individually controlled. For example, by independently controlling each of the thermoelectric elements 130, it is possible to control adjacent thermal zones to have a temperature gradient. Alternatively, by independently controlling each of the thermoelectric elements 130, it is possible to reduce the temperature deviation of the thermal zones.

The thermoelectric elements 130 may be arranged side by side in the air flow direction of the duct 210. The thermal module 10 may uniformly control the temperature of the thermal block 110 in the flow direction of air by independently controlling each of the thermoelectric elements 130. For example, the power of the thermoelectric element 130 located below the thermal block 110 having a relatively low temperature in the air flow direction during the heating process may be increased, or the power of the thermoelectric element 130 located below the thermal block 110 having a relatively high temperature in the air flow direction during the cooling process may be increased.

The electrical resistance element 120 generates heat by a Joule heating method. For example, the electrical resistance element 120 may be a flexible heater, a film heater, a Kapton heater, a polyimide heater, or a heat FPCB. The electrical resistance element 120 may be used to uniformly control the temperature of the thermal block 110. For example, heat may be generated using the electrical resistance element 120 located in a thermal zone having a relatively low temperature among the plurality of thermal zones of the thermal block 110 to increase the temperature of the corresponding thermal zone.

Hereinafter, the heat FPCB (Flexible Printed Circuit Board) is a conductive line formed on a substrate using a heat-resistant plastic film such as Polyester (PET) or Polyimide (PI), which is a flexible material, and may be used in the broadest sense. The heat FPCB is used as a concept comprising a flexible heater, a film heater, a Kapton heater, a polyimide heater. The heat FPCB is a heater formed by forming a pattern between polyimide films by using a metal foil to insulate both sides, is resistant to heat resistance, chemical resistance, and electrical noise, and has a very thin thickness (0.3 T), so that it has good thermal conductivity and is flexible, so it can be attached to a curved surface.

In addition, a first heat transfer member 161 may be provided between the thermoelectric element 130 and the thermal block 110, and a second heat transfer member 162 may be provided between the thermoelectric element 130 and the first heat sink 150. The first and second heat transfer members 161 and 162 may be formed of a material having high thermal conductivity and may be formed of a tape, a pad, a film, or an adhesive. For example, the first and second heat transfer members 161 and 162 may be formed of acrylic foam, PET, or copper foil.

The first heat transfer member 161 may be provided to have an area covering the thermal block 110, and the second heat transfer member 162 may be provided to have an area covering each thermoelectric element 130. The first heat transfer member 161 may be provided in a width covering the plurality of thermoelectric elements 130 for uniform heating of the thermal block 110. In addition, the second heat transfer member 162 may be provided in a width covering each thermoelectric element 130 for individual cooling of the thermal block 110. For example, when six thermoelectric elements 130 are provided, one heat transfer member covering the width of the six thermoelectric elements 130 may be provided as a single layer in the first heat transfer member 161, and six heat transfer members covering the width of the single thermoelectric element 130 may be arranged side by side to be provided as a single layer in the second heat transfer member 162.

In addition, a third heat transfer member (not shown) may be provided between the electrical resistance element 120 and the thermal block 110. The third heat transfer member may be made of a material having high thermal conductivity, and may be made of a tape, a pad, a film, or an adhesive. For example, the third heat transfer member may be an acrylic foam, a PET, or a copper foil, and the material may be selected in consideration of adhesion, heat resistance, conductivity, and flame retardancy.

The electrical resistance element 120 may be disposed between the reaction container and the thermal block 110, and the first cover 20 may be disposed between the reaction container and the electrical resistance element 120.

A heat insulating member may be provided between the electrical resistance element 120 and the first cover 20. The first cover 20 may cover the top of the heat insulating member. The heat insulating member is formed of a material having low thermal conductivity, and may be, for example, silicon, a silicon sponge, or a sealant. The heat insulating member may prevent heat of the electrical resistance element 120 from leaking upward through the first cover 20, thereby increasing thermal efficiency of the electrical resistance element 120. In addition, the heat insulating member may prevent the heat of the electrical resistance element 120 from being directly transferred to the reaction container.

The thermal element may be electrically connected to the thermal circuit board 140. For example, the heat FPCB in which the electrical resistance element 120 is provided may be electrically connected to the thermal circuit board 140 and may be detachably connected thereto. In addition, the thermoelectric element 130 may be electrically connected to the thermal circuit board 140 using a metal wire.

The thermal circuit board 140 may be a PCB that is positioned inside the first cover 20 and provided with a first connection portion 141 at on one side thereof. In addition, the first connection portion 141 of the thermal circuit board 140 may be exposed to one side surface of the first cover 20 and coupled to a connection unit 400 to be described later. To this end, the first cover 20 may form a first opening exposing the first connection portion 141 of the thermal circuit board 140.

In addition, the first connection portion 141 of the thermal circuit board 140 may be located at one side of the first cover 20 facing a second direction (y-axis direction in FIG. 1) perpendicular to a plane direction with respect to a first direction (x-axis direction in FIG. 1), which is a flow direction of air passing through the duct 210.

In addition, the thermal circuit board 140 may have a space formed inside it. When viewed from the side, the internal space of the thermal circuit board 140 may be formed to accommodate at least one of the thermal block 110 and thermal element therein. And when viewed from above, the internal space of the thermal circuit board 140 may be formed to accommodate the thermal block 110 therein. The thermal circuit board 140 may be provided along the periphery of the thermal block 110 and may be formed in a ‘ [symbol] ’ or ‘ [symbol] ’ shape.

In addition, the thermal element may be electrically connected to the main controller or the power module of the control unit 300 to generate heat using the power provided from the power module.

The first heat sink 150 may be positioned under the thermal block 110. The first heat sink 150 is a passive heat exchanger and efficiently dissipates heat from the thermal block 110.

The heat sink may be formed of metal, ceramic, or plastic. The heat sink may comprise a plurality of cooling fins or heat radiating fins to increase a heat radiating area. The cooling fins formed in the heat sink may be arranged in various directions depending on the embodiment. The shape of the heat sink and the length, arrangement, and thickness of the cooling fins may be provided in various ways.

The first heat sink 150 may comprise a body supporting the thermal block 110 and a plurality of first cooling fins 151 extending downward from the body. For example, the first cooling fin 151 may be provided as a straight fin and may be arranged in one direction under the body of the first heat sink 150. For example, the first cooling fins 151 may extend in a blowing direction of the duct 210, and the plurality of first cooling fins 151 may be disposed adjacent to each other in a direction perpendicular to the blowing direction of the duct 210. Heat exchange with the first cooling fins 151 may occur while air flows into the space between the adjacent first cooling fins 151.

The cooling unit 200 and the control unit 300 will be described with reference to FIGS. 4 and 5 again.

The control unit 300 may comprise a control circuit board 310 and a second heat sink 320.

The control circuit board 310 may be a PCB that is positioned inside the second cover 40 and provided with a second connection portion 311 at one side thereof. In addition, the second connection portion 311 of the control circuit board 310 may be exposed to one side surface of the second cover 40 and coupled to the connection unit 400 to be described later. To this end, the second cover 40 may form a second opening exposing the second connection portion 311 of the control circuit board 310.

In addition, the second connection portion 311 of the control circuit board 310 may be located on one side surface of the second cover 40 facing a second direction perpendicular to a plane direction in a first direction, which is a flow direction of air passing through the duct 210.

In addition, the first connection portion 141 of the thermal circuit board 140 and the second connection portion 311 of the control circuit board 310 may be provided to face the same direction. That is, the first connection portion 141 and the second connection portion 311 may be exposed to one side surface of the integrated module in the second direction, which is configured by coupling the first cover 20, the middle frame 30, and the second cover 40, and the connection unit 400 may be coupled to the one side surface of the integrated module.

The second heat sink 320 may be positioned on the control circuit board 310. The second heat sink 320 is a passive heat exchanger that efficiently dissipates heat from the control circuit board 310.

The second heat sink 320 may comprise a plurality of second cooling fins 321 extending upward. For example, the second cooling fin 321 may be provided as a straight fin and may be arranged in one direction on the body of the second heat sink 320. For example, the second cooling fins 321 may extend in the blowing direction of the duct 210, and the plurality of second cooling fins 321 may be disposed adjacent to each other in a direction perpendicular to the blowing direction of the duct 210. Heat exchange with the second cooling fins 321 may occur while air flows into the space between the adjacent second cooling fins 321.

The first cooling fin 151 of the first heat sink 150 and the second cooling fin 321 of the second heat sink 320 may be provided to be spaced apart from each other in the vertical direction. Accordingly, cooling efficiency may be improved while air flows into the space between the first cooling fins 151 and the second cooling fins 321.

The first cooling fins 151 of the first heat sink 150 and the second cooling fins 321 of the second heat sink 320 may be alternately disposed in a second direction perpendicular to a first direction, which is a flow direction of air passing through the duct 210, in a planar direction. Accordingly, it is possible to improve cooling efficiency by increasing a velocity of the air flow while minimizing interference between the air flow passing between the first cooling fins 151 and the air flow passing between the second cooling fins 321.

Meanwhile, although not shown in the drawings, a duct separation partition wall (not shown) may be provided between the first cooling fin 151 and the second cooling fin 321. The duct separation partition wall may be provided in a plate shape extending in the air flow direction of the duct 210, and a top surface of the duct separation partition wall may be provided adjacent to the first cooling fin 151, and a bottom surface thereof may be provided adjacent to the second cooling fin 321. The duct separation partition may separate the air flow cooling the first heat sink 150 and the air flow cooling the second heat sink 320, thereby helping the thermal cycling to form a more accurate and predictable temperature gradient.

In addition, the duct separation partition wall may be thermally connected while being supported by the second heat sink 320. The heat of the duct separation partition wall may be circulated to the second heat sink 320.

The cooling unit 200 may comprise a cooling fan 220 and a duct 210.

The cooling fan 220 provides external air for cooling the first heat sink 150 and the second heat sink 320. Various known types of cooling fans 220 may be used as the cooling fan 220. For example, axial fans, centrifugal fans, and cross flow fans may be used.

The cooling fan 220 may comprise an inlet cooling fan or a first cooling fan 220 located at an inlet side of the duct 210 and an outlet cooling fan or a second cooling fan 220 located at an outlet side of the duct 210. According to an embodiment, the first cooling fan 220 and the second cooling fan 220 may be provided in the x-axis direction or the first direction. However, the arrangement direction of the first cooling fan 220 and the second cooling fan 220 may vary depending on the shape of the duct 210.

The duct 210 may comprise both side surfaces partitioning the flow passage of air. A first heat sink 150 and a second heat sink 320 may be positioned at an upper portion and a lower portion of the duct 210, respectively. Both sides of the duct 210 may be connected the first cooling fan 220 and the second cooling fan 220. An inlet of the duct 210 adjacent to the first cooling fan 220 may have a gradient surface for expanding a flow area of air, and an outlet of the duct 210 adjacent to the second cooling fan 220 may have a gradient surface for reducing the flow area of air.

Meanwhile, although not shown in the drawings, a skirt for reducing vortex formation of air may be provided between the inlet of the duct 210 and the heat sink. For example, the skirt may be provided with a shape-deformable material and may have a shape for guiding a flow path of air toward the cooling fin.

Meanwhile, the thermal module 10 may further comprise a heat lid (not shown) located above the reaction container. The heat lid may be functionally understood as a component of the thermal module 10 but is not comprised in the integrated module partitioned by the housing. The heat lid is located above the reaction container and may be electrically connected to the control unit 300.

The heat lid may prevent the occurrence of condensation by providing heat to the top surface of the reaction container. In addition, the heat lid may provide heat and pressure to the top surface of the reaction container. For example, the heat lid may contact the covers of the reaction containers and press the covers of the reaction containers to provide pressure to the reaction containers. In addition, the heat lid may maintain a high temperature. For example, the heat lid may comprise a heat plate (not shown) that maintains a temperature of 105° C.

The heat lid comprises a plurality of holes. The holes of the heat lid are formed at positions corresponding to the wells of the thermal block 110. The excitation light and the emission light may pass through the heat lid hole.

Meanwhile, the thermal module 10 may further comprise a temperature sensor.

The temperature sensor may further comprise a block temperature sensor for measuring a temperature of the thermal block 110, a heat sink temperature sensor for measuring a temperature of the heat sink, an air temperature sensor for measuring an air temperature of the duct 210, and a heat lid temperature sensor for measuring a temperature of the heat lid.

The block temperature sensor may comprise a plurality of block temperature sensors corresponding to a plurality of thermal zones of the thermal block 110. One or more block temperature sensors may be provided in each thermal zone of the thermal block 110. For example, when the thermal block 110 is divided into a plurality of thermal zones in the longitudinal direction (FIG. 1, x-axis direction), a plurality of block temperature sensors may be provided in the thermal zone of each thermal block 110 in a width direction (FIG. 1, y-axis direction) perpendicular to the longitudinal direction.

The thermal zone of the thermal block 110 may be defined by physically dividing the thermal block 110. Alternatively, the thermal zone of the thermal block 110 may be virtually divided and defined in terms of heat transfer. For example, when a number of thermoelectric elements 130 are arranged in the longitudinal direction of the thermal block 110, the thermal block 110 may comprise a x n thermal zones (n is a positive integer).

According to an embodiment, the thermoelectric element 130 may comprise six thermoelectric elements 130 disposed in one direction of the thermal block 110. Here, the one direction in which the thermoelectric elements 130 are disposed may be an air flow direction of the duct 210. The thermoelectric elements 130 are disposed adjacent to each other, and each of the thermoelectric elements 130 extends in a direction perpendicular to one direction of the thermal block 110. Here, the direction in which the thermoelectric element extends is along the width of the thermal block.

The thermal block 110 may be divided into six thermal zones in the arrangement direction of the thermoelectric element 130. In addition, the thermal block 110 may be divided into a plurality of thermal zones according to the arrangement of the block temperature sensors. For example, when six thermoelectric elements 130 are disposed in the air flow direction of the duct 210, and two block temperature sensors are disposed in the longitudinal direction of each thermoelectric element 130, so that a total of 12 block temperature sensors are disposed, the thermal block 110 may be divided into at least six thermal zones and at most 12 thermal zones.

The heat sink temperature sensor measures the temperature of the heat sink and may be provided as a resistance temperature sensor. The resistance temperature sensor includes RTD (Resistance Temperature Detector). A plurality of heat sink temperature sensors may be provided. For example, four heat sink temperature sensors may be provided by dividing the heat sink into front/rear/left/right. The heat sink temperature sensor may be mounted on the heat FPCB. The flexible heater for heat sink 170 (see FIG. 7) provided with the heat sink temperature sensor may be electrically connected to a thermal element connection PCB to be described later.

The air temperature sensor measures temperatures of the input and output terminals of the duct 210 and may be provided as a thermo-variable resistor (such as NTC (Negative Temperature Coefficient) thermistor). The air temperature sensor may be connected to the flexible heater for heat sink 170 through a wire. According to an embodiment, the air temperature sensor may comprise a first air temperature sensor that measures the temperature of the air at the inlet side of the duct 210 and a second air temperature sensor that measures the temperature of the air at the outlet side of the duct 210.

The heat lid temperature sensor measures the temperature of the heat lid and may be provided as a resistance temperature sensor. The resistance temperature sensor includes RTD (Resistance Temperature Detector). A plurality of heat lid temperature sensors may be provided. For example, five heat lid temperature sensors may be provided by dividing the central area and four corner areas of the thermal block 110. The heat lid temperature sensor may be mounted on a flexible heater for heat lid. The flexible heater for heat lid provided with the heat lid temperature sensor may be electrically connected to the interface PCB through a heat lid connection FPCB.

Referring to FIG. 7, the thermal module 10 may further comprise a connection unit 400 electrically connecting the thermal unit 100 and the control unit 300. The connection unit 400 may extend in a vertical direction at one side of the integrated module in which the thermal unit 100, the cooling unit 200, and the control unit 300 are combined, and may be detachably coupled to the integrated module.

Specifically, the thermal circuit board 140 of the thermal unit 100 comprises a first connection portion 141 connected to the control circuit board 310, and the control circuit board 310 comprises a second connection portion 311 connected to the first connection portion 141. In addition, the connection unit 400 may electrically connect the first connection portion 141 and the second connection portion 311 and may be detachably coupled to the first connection portion and the second connection portion.

The connection unit 400 comprises a connection circuit board 410 that electrically connects the control circuit board 310 and the thermal circuit board 140. Specifically, the connection circuit board 410 may extend in the vertical direction (z-axis direction in FIG. 1) to connect the first connection portion 141 of the thermal circuit board 140 positioned relatively above and the second connection portion 311 of the control circuit board 310 positioned relatively below. And the connection circuit board 410 may comprise a first connector 401 electrically connected to the first connection portion 141 of the thermal circuit board 140 and a second connector 402 electrically connected to the second connection portion 311 of the control circuit board 310.

The connection circuit board 410 may further comprise a third connector 403 electrically connected to the flexible heater for heat lid. And The connection circuit board 410 may further comprise a fourth connector 404 electrically connected to a main control board (not shown) of the thermal cycler. The fourth connector 404 connecting the connection circuit board 410 to the main control board may comprise a power port and a communication port.

In addition, the connection unit 400 may be detachably coupled to an integrated module configured by coupling the thermal unit 100, the cooling unit 200, and the control unit 300. Specifically, the connection unit 400 may be detachably coupled to the first connection portion 141 and the second connection portion 311. To this end, the connection between the first connection portion 141 and the second connection portion 311 and the connection unit 400 may constitute a board-to-board connector and may comprise a pin-through hole or a magnetic structure for alignment.

The connection unit 400 may be connected to a side surface of the integrated module other than a side surface on which the cooling fan 220 is provided. Alternatively, when a direction connecting a pair of cooling fans 220 facing each other is referred to as a first direction, the connection unit 400 may be connected to a side surface of a second direction crossing the first direction. Here, the term “side surface in the second direction” means that a direction perpendicular to the side surface is the second direction. For example, the cooling fan 220 is provided on a side surface in the x direction, and the connection unit 400 is connected to a side surface in the y direction and extends in the z direction.

The connection unit 400 may be detachably coupled to an integrated module configured by coupling the first cover 20, the middle frame 30, and the second cover 40. The first cover 20 may form an opening exposing the first connection portion 141, and the second cover 40 may form an opening exposing the second connection portion 311.

The middle frame 30 of the thermal module 10 according to an embodiment of the disclosure may be in thermal contact with the first heat sink 150 to function as a heat sink of the thermal block 110.

Referring to FIGS. 2, 6, and 7, the first heat sink 150 may comprise a body 152 supporting the thermal block 110, a first cooling fin 151 extending below the body 152, and a flange portion 153 protruding to the outside of the body 152 and extending. The flange portion 153 may be configured to protrude outward from the thermal block 110 when viewed from above and may be configured to protrude outward from the first cooling fin 151 when viewed from below.

The middle frame 30 may comprise a body forming a space for accommodating the body 152 of the first heat sink 150 therein, an upper coupling portion coupled to the first cover 20 at an upper portion of the body, and a lower coupling portion coupled to the second cover 40 at a lower portion of the body. In this case, the body of the middle frame 30 may be configured such that the outer surface thereof is recessed further inward than the outer surfaces of the first cover 20 and the second cover 40. That is, the body of the middle frame 30 may be positioned inside the first cover 20 in the second direction (or the y-axis direction) when viewed from above.

The flange portion 153 of the first heat sink 150 may be supported on the body of the middle frame 30. A frame heat transfer member 32 may be provided at a portion where the first heat sink 150 and the middle frame 30 thermally contact each other. For example, a frame heat transfer member 32 may be provided between a top surface of the body of the middle frame 30 and the flange portion 153 of the first heat sink 150.

The frame heat transfer member 32 may extend along a body of the middle frame 30. For example, the frame heat transfer member 32 may extend in the first direction (x-axis direction in FIG. 1), which is an air flow direction of the duct 210. A pair of frame heat transfer members 32 may be provided at both sides of the duct 210, respectively.

The middle frame 30 may further comprise external cooling fins 31 protruding outward from the body. A plurality of external cooling fins 31 may be arranged side by side along the first direction, which is an air flow direction of the duct 210. In addition, the external cooling fins 31 may extend in a second direction (y-axis direction in FIG. 1) perpendicular to the first direction in a plane direction. In addition, the external cooling fin 31 may be provided to extend from one side surface of the body in the second direction and not to protrude outward from the side surface of the first cover 20 in the second direction.

The middle frame 30 may comprise upper external cooling fins 31 and lower external cooling fins 31 spaced apart from each other in a vertical direction. Cooling efficiency may be increased while air flows into the space between the upper external cooling fins 31 and the lower external cooling fins 31. In addition, the external cooling fins 31 may be provided to be spaced apart from the first cover 20 or the upper coupling portion of the middle frame 30, and the cooling efficiency may be increased while air flows into a space provided above the external cooling fins 31. In addition, the external cooling fin 31 may be provided to be spaced apart from the second cover 40 or the lower coupling portion of the middle frame 30, and the cooling efficiency may be increased while air flows into a space provided below the external cooling fin 31.

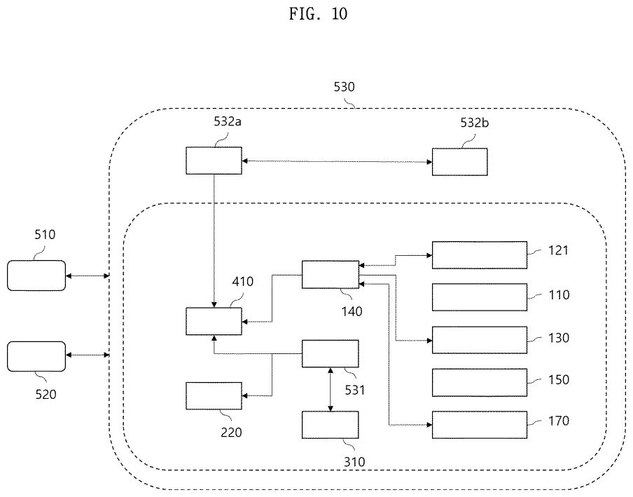

FIG. 10 is a view illustrating a configuration of a controller of a thermal cycler.

Referring to FIG. 10, the controller of the thermal cycler may comprise an integrated control module 510, an optical control module 520, and a thermal control module 530. In addition, although not shown in FIG. 10, a driving control module for controlling mechanical driving of the thermal cycler may be further comprised.

The control part of the thermal cycler according to an embodiment of the disclosure may be modularized. For example, the thermal cycler may comprise a distributed control module. The distributed control module may comprise an optical control module 520 for controlling the optical module, a thermal control module 530 for controlling the thermal module 10, a drive control module for controlling the drive unit, and an integrated control module 510 for integrally controlling the optical control module 520, the thermal control module 530, and the drive control module.

As described above, many advantages are brought about by distributing separate control modules in modular units that perform independent functions and providing an integrated control module that integrates them.

For example, if a problem occurs or an upgrade is required in some modules, only the corresponding distributed control module may be replaced or repaired, making maintenance easy.

Conventionally, when a worker needed to replace or repair the thermal module, the thermal cycler had to be disassembled, and the integrated control board had to be removed along with the thermal module. At this time, there was a hassle of disassembling and reassembling numerous connections connected to the integrated control board, and there were frequent cases in which the entire integrated control board had to be replaced.

However, when using distributed control modules, only the thermal module 10 and thermal control module 530 need to be separated for replacement and repair without separating the integrated control module 510. During reinstallation, work is made easy as only the connectors of the thermal control module 530 and the integrated control module 510 need to be reconnected.

The thermal control module 530 may comprise a control circuit board 310, a driver circuit board 531, a connection circuit board 410, a thermal circuit board 140, a thermal block circuit board 121, a heat sink circuit board 170, and a heat lid circuit board 532.

Hereinafter, the thermal block circuit board 121 comprises a flexible heater for thermal block, the heat sink circuit board 170 comprises a flexible heater for heat sink, and the heat lid circuit board 532 comprises a heat lid connection circuit board 532a and a heat lid heating circuit board 532b.

The control circuit board 310 and the driving circuit board 531 may be provided as separate boards and connected to each other or may be comprised in one board. In some cases, the control circuit board 310 may be used as a meaning comprising a driving circuit board 531.

The control circuit board 310 may be provided as a control PCB. The control circuit board 310 may control all functions of the thermal module 10. For example, the control circuit board 310 may control thermal cycling, temperature gradients, and temperature of the heat lid, and may sense and process the current or temperature. The control circuit board 310 may process data while communicating with the integrated control module 510 and may perform synchronization while communicating with the optical control module 520. For example, the control circuit board 310 may comprise Ethernet for communicating with the integrated control module 510.

The control circuit board 310 may be provided as the control PCB comprising an MCU and peripheral circuits. The control circuit board 310 may comprise a circuit for controlling a TEC 130, a circuit for controlling a heat lid, and a circuit for controlling a cooling fan 220. The control circuit board 310 may be modularized to match the thermal module 10 individually. Therefore, the control circuit board 310 may maintain a state optimized for the thermal module 10, and when the thermal module 10 is replaced or repaired, the control circuit board 310 may be replaced or repaired together.

The driving circuit board 531 may be provided as a driver PCB. The driving circuit board 531 may drive the electrical resistance element 120 and the thermoelectric element 130 for a temperature gradient, and the heat lid, and may sense a current. And the driving circuit board 531 may be connected to the control circuit board 310 and the connection circuit board 410.

The driving circuit board 531 may comprise a circuit for driving a flexible heater for thermal block 121, a circuit for driving a flexible heater for heat sink 170, and a circuit for driving a flexible heater for heat lid 532b. And the driving circuit board 531 may further comprise a circuit for driving the cooling fan 220. In addition, the driving circuit board 531 may comprise circuits divided into heating sections for temperature control for each zone.

The connection circuit board 410 may be provided as an interface PCB. The connection circuit board 410 may be connected to the driving circuit board 531, the thermal circuit board 140, and the heat lid connection circuit board 532a. In addition, the connection circuit board 410 may comprise a circuit connected to the integrated control module 510 and the optical control module 520.

The connection circuit board 410 may comprise a connection circuit that connects the driving circuit board 531 and the thermal circuit board 140. The connection circuit board 410 may comprise a high current connection circuit to supply power to the TEC 130, the flexible heat for thermal block 120, and the flexible heater for heat lid 532b.

The thermal circuit board 140, the flexible heater for thermal block 121, and the flexible heater for heat sink may be provided as separate boards and connected to each other or may be integrated into one board.

The thermal circuit board 140 may be provided as a thermal element/temperature sensor connection PCB. The thermal circuit board 140 may be connected to a TEC (thermoelectric element, Peltier), a flexible heater for thermal block 121, and a flexible heater for heat sink 170. In addition, the thermal circuit board 140 may comprise a receiver for converting a temperature detection signal (analog) of a temperature sensor into a digital signal.

The thermal circuit board 140 may comprise a TEC connection circuit and connector, a high-precision RTD circuit, and a high-resolution analog to digital conversion circuit.

The flexible heater for thermal block 121 may be a flexible heater for thermal block 121. The flexible heater for thermal block 121 may heat the thermal block and perform high-precision temperature sensing. The flexible heater for thermal block 121 may implement Joule heating through a thermal resistance pattern design and may be mounted with a resistance temperature sensor. The flexible heater for thermal block 121 may have a separate a heating section for temperature gradient control.

In addition, the flexible heater for thermal block 121 may be attached to the top surface of the thermal block. In addition, a thermal conduction layer may be provided between the flexible heater for thermal block 121 and the thermal block to increase thermal conductivity. In addition, the flexible heater for thermal block 121 may comprise a hole corresponding to the recess of the thermal block. Thus, when the reaction container is mounted on the thermal block, the well of the reaction container may pass through the hole formed in the flexible heater for thermal block 121.

In addition, the flexible heater for thermal block 121 may comprise a channel corresponding to the thermal zone of the thermal block. For example, when the thermal block is divided into six thermal zones, the flexible heater for thermal block 121 may comprise six channels. In addition, the flexible heater for thermal block 121 may independently control each channel.

In addition, each channel of the flexible heater for thermal block 121 may comprise two temperature sensors, and the flexible heater for thermal block 121 may constitute a total of 12 temperature sensors.

The temperature sensor may be positioned adjacent to an edge of the thermal block. Therefore, the flexible heater for thermal block 121 may comprise two temperature sensors for measuring temperatures of both edges of the thermal block in each channel.

The flexible heater for heat sink may be a flexible heater for heat sink 170. The flexible heater for heat sink 170 may sense a temperature of the heat sink to increase thermal efficiency of thermal cycling and increase cooling efficiency. The flexible heater for heat sink 170 may comprise a high-precision RTD circuit.

The flexible heater for heat sink may be attached to a bottom surface of the heat sink. In addition, a thermal conduction layer is provided between the flexible heater for heat sink and the heat sink to increase thermal conductivity. And when viewed from above, the internal space of the flexible heater for heat sink may be formed to accommodate the first cooling fin 151 therein. The flexible heater for heat sink may be provided along the periphery of the first cooling fin 151 and may be formed in a ‘ [symbol] ’ or ‘ [symbol] ’ shape.

In addition, the flexible heater for heat sink 170 may comprises four channels and temperature sensors (such as thermistor) provided in each channel. For example, the flexible heater for heat sink 170 may comprise four corner channels and four temperature sensors to sense the temperature at each corner of the heat sink.

The heat lid connection circuit board 532a and flexible heater for heat lid 532b may be provided as separate boards and connected to each other or may be comprised in one board.

The heat lid connection circuit board 532a may be provided as a heat lid connection FPCB. The heat lid connection circuit board 532a may be connected to the connection circuit board 410. The heat lid connection circuit board 532a may convert a temperature sensing signal (analog) of the temperature sensor into a digital signal. The heat lid connection circuit board 532a may comprise a high-precision RTD circuit and a high-resolution analog to digital conversion circuit.

The heat lid circuit board 532 may comprise a flexible heater for heat lid 532b. The flexible heater for heat lid 532b may expect to reduce reagent evaporation by heating heat lid. In addition, the flexible heater for heat lid 532b may perform high-precision temperature sensing. The flexible heater for heat lid 532b may perform Joule heating through a thermal resistance pattern design and may be mounted with a resistance temperature sensor. The flexible heater for heat lid 532b may have a separate a heating section for over-heating control.

In addition, the flexible heater for heat lid 532b may be provided at a position spaced upward from the top surface of the thermal block. In addition, the flexible heater for heat lid 532b move relatively to the thermal block to be close to or away from the thermal block. In addition, the flexible heater for heat lid 532b may comprise a hole corresponding to the recess of the thermal block. Therefore, it is possible to constitute a path through which excitation light is irradiated to the reaction container or emission light is emitted from the reaction container.

In addition, the flexible heater for heat lid 532b may comprise channels corresponding to a central area and an edge area of the thermal block. For example, the flexible heater for heat lid 532b may comprise five channels comprising a central channel and four corner channels. In addition, the flexible heater for heat lid 532b may independently control each channel.

In addition, each channel of the flexible heater for heat lid 532b may be provided with one temperature sensor, and the flexible heater for heat lid 532b may be provided with a total of five temperature sensors.

The above description is merely illustrative of the technical idea of the present disclosure, and those skilled in the art to which the present disclosure pertains will be able to make various modifications and variations without departing from the essential quality of the present disclosure. Therefore, the embodiments disclosed in the present disclosure are not intended to limit the technical idea of the present disclosure, but to explain it, and the scope of the technical idea of the present disclosure is not limited by these embodiments. The protection scope of the disclosure should be interpreted by the following claims, and all technical ideas within the scope equivalent thereto should be interpreted as being comprised in the scope of the disclosure.

### LEGEND OF REFERENCE NUMBER

10: thermal module, 20: first cover, 30: middle frame, 31: external cooling fin, 32: frame heat transfer member, 40: second cover, 100: thermal unit, 110: thermal block, 120: electrical resistance element, 121: flexible heater for thermal block, 130: thermoelectric element, 140: thermal circuit board, 141: first connection portion, 150: first heat sink, 151: first cooling fin, 152: body, 153: flange portion, 161: first heat transfer member, 162: second heat transfer member, 170: flexible heater for heat sink, 200: cooling unit, 210: duct, 220: cooling fan, 300: control unit, 310: control circuit board, 311: second connection portion, 320: second heat sink, 321: second cooling fin, 400: connection unit, 410: connection circuit board.

1. A thermal cycler comprising:
a thermal unit comprising a thermal block configured to receive a sample and a thermal element in thermal contact with the thermal block;
a control unit comprising a control circuit board configured to control thermal cycling of the thermal element; and
a cooling unit comprising a duct positioned between the thermal unit and the control unit and configured to provide an air flow passage, and a cooling fan configured to provide an air flow to the duct,
wherein the thermal unit, the control unit, and the cooling unit are combined into an integrated module.

2. The thermal cycler according to claim 1, wherein the thermal unit, the cooling unit, and the control unit are combined in this order, and the thermal unit and the control unit are simultaneously cooled by air passing through a duct of the cooling unit.

3. The thermal cycler according to claim 2, wherein the thermal unit, the cooling unit, and the control unit are stacked downward in this order.

4. The thermal cycler according to claim 3, further comprising a connection unit electrically connecting the thermal unit and the control unit,
wherein the connection unit extends in a vertical direction at one side of the integrated module and is detachably coupled to the integrated module.

5. The thermal cycler according to claim 1, wherein the thermal unit further comprises a thermal circuit board electrically connected to the thermal element, and
wherein the thermal circuit board comprises a first connection portion connected to the control circuit board.

6. The thermal cycler according to claim 5, further comprising a connection unit electrically connecting the first connection portion and a second connection portion of the control circuit board, and detachably coupled to the first connection portion and the second connection portion.

7. The thermal cycler according to claim 6, wherein the cooling fan comprises a pair of cooling fans respectively located at both ends of the duct, wherein the cooling fans are installed at side surfaces of the integrated module in a first direction, and
wherein the first connection portion, the second connection portion, and the connection unit are all located at one of side surfaces of the integrated module in a second direction crossing the first direction.

8. The thermal cycler according to claim 1, wherein the duct of the cooling unit extends in a first direction, the thermal unit comprises a first heat sink configured to dissipate heat of the thermal block, and the control unit comprises a second heat sink configured to dissipate heat of the control circuit board, and
wherein each of the first heat sink and the second heat sink comprises a plurality of cooling fins extending in the first direction, and the cooling fins are arranged in a second direction perpendicular to the first direction.

9. The thermal cycler according to claim 8, wherein the cooling fins of the first heat sink and the cooling fins of the second heat sink are alternately disposed in the second direction.

10. The thermal cycler according to claim 1, wherein the thermal unit comprises a first heat sink configured to dissipate heat from the thermal block,
wherein the control unit comprises a second heat sink configured to dissipate heat from the control circuit board, and
wherein a flow of air passing through the duct is configured to cool the first heat sink and the second heat sink at the same time.

11. The thermal cycler according to claim 1, wherein the cooling unit further comprises a middle frame to which the cooling fan is coupled, and
wherein the thermal unit and the control unit are coupled to the middle frame in opposite directions, respectively.

12. The thermal cycler according to claim 11, further comprising a first cover coupled to one side of the middle frame and configured to cover the top of the thermal unit and a second cover coupled to the other side of the middle frame and configured to cover the bottom of the control unit,
wherein the first cover comprises a plurality of openings corresponding to the recesses of the thermal block.

13. The thermal cycler according to claim 1, wherein the thermal unit further comprises a first heat sink comprising a first cooling fin for dissipating heat of the thermal block,
wherein the control unit further comprises a second heat sink comprising a second cooling fin for dissipating heat of the control circuit board,
wherein the cooling unit further comprises a cooling fan for providing an air flow to the duct, and
wherein the flow of air passing through the duct is configured to simultaneously cool the first heat sink and the second heat sink.

14. The thermal cycler according to claim 13, wherein the thermal element, the first heat sink, the second heat sink, and the control circuit board are arranged in a downward direction in order.

15. The thermal cycler according to claim 13, wherein the thermal block comprises a plurality of recesses accommodating each well of the reaction container, wherein the thermal element comprises a thermoelectric element and an electrical resistance element, and wherein the electrical resistance element is provided as a flexible heater comprising holes corresponding to the recesses of the thermal block.

16. The thermal cycler according to claim 1, further comprising a connection unit configured to electrically connect the thermal unit and the control unit,
wherein the thermal unit, the control unit, the cooling unit, and the connection unit are combined into an integrated module.

17. The thermal cycler according to claim 16, wherein the thermal unit, the cooling unit, and the control unit are combined in a first direction in this order, and the connection unit is located at one side of the thermal unit and the control unit and extends in a direction parallel to the first direction.

18. The thermal cycler according to claim 15, wherein the flexible heater for thermal block is configured to heat the thermal block on the thermal block,
wherein the thermoelectric element is configured to exchange heat with the thermal block under the thermal block, and
wherein the first heat sink is thermally connected to the thermoelectric element,
the thermal cycler further comprising a heat insulating member configured to cover the top of the flexible heater for thermal block; and
a first cover configured to cover the top of the heat insulating member and the side of the thermal block, and
wherein the flexible heater for thermal block, the heat insulating member, and the first cover comprise openings corresponding to the respective recesses of the thermal block.

19. The thermal cycler according to claim 18, wherein the thermal block comprises a plurality of pillars protruding from a top surface, wherein each of the recesses is formed in the pillar, and wherein the pillar penetrates through the flexible heater for thermal block and holes in the heat insulating member.
